(19) United States
(12) Patent Application Publication
(10) Pub. No.: US 2012/0198020 A1
(43) Pub. Date: Aug. 2, 2012

(54) CONTENT DISTRIBUTION WITHIN A SERVICE PROVIDER NETWORK

(75) Inventors: Benjamin J. PARKER, Vacaville, CA (US); Samir AIT-AMEUR, Fremont, CA (US); Emerando M. DELOS REYES, Pleasant Hill, CA (US); Brian W. JOE, New York, NY (US)

(73) Assignee: VERIZON PATENT AND LICENSING, INC., Basking Ridge, NJ (US)

(21) Appl. No.: 13/019,592

(22) Filed: Feb. 2, 2011

(51) Int. Cl. G06F 15/16

(52) U.S. Cl. 709/217

(57) ABSTRACT

A system, associated with a service provider network, is configured to receive, from a content provider, a request for information associated with a community of interest (COI) that corresponds to a user device, where the information associated with the COI includes information associated with preferred user devices, with preferred content providers, or with preferred content; determine whether the content provider is authorized to receive the information associated with the COI; retrieve the information associated with the COI based on a determination that the policy information includes an indication that the content provider is authorized to receive the information associated with the COI; send, to the content provider, the information associated with the COI, which enables the content provider to generate particular content that is customized to the user device; receive the particular content from the content provider; and send the particular content to the user device.

### BACKGROUND

Service provider networks transport network traffic associated with a variety of services, applications, and content. The network traffic may include voice, text, video and/or data. Service provider networks are sized and/or scaled in order to transport an increasing quantity of traffic that is sent by and/or received from more and more users and/or content providers. Additionally, the increase in the quantity of traffic corresponds to an expanding demand for various types of services, applications, and/or content.

Unfortunately, content providers transport content to user devices in a manner that is not always optimum for service provider networks via which the user devices receive the content. Transporting the content in a manner that is not optimum may cause congestion and/or other conditions to occur in the service provider networks. Additionally, the content is often transported to a variety of types of user devices in a manner that is difficult for all or a portion of the user devices to receive, process, or render.

### BRIEF DESCRIPTION OF THE DRAWINGS

FIG. 1 is a diagram of an example environment in which systems and/or methods, described herein, may be implemented;

FIG. 2 is a diagram of example devices of a content distribution system of FIG. 1;

FIG. 3 is a diagram of example components of one or more of the devices of FIGS. 1 and 2;

FIG. 4 is a flow chart of an example process for storing content according to an implementation described herein;

FIG. 5 is a diagram of an example data structure that stores information associated with traffic conditions within a radio access network according to an implementation described herein;

FIG. 6 is a flow chart of an example process for optimizing a manner in which content is served based on a condition being detected in a radio access network associated with the service provider network of FIG. 1;

FIG. 7 is a diagram of an example analytics and reporting data structure that stores information associated with preferred content, usage patterns, and network performance analytics associated with a user device of FIG. 1;

FIG. 8 is a flow chart of an example process for performing an operation to obtain analytics and reporting information and/or to identify a community of interest associated with the user device of FIG. 1; and

FIG. 9 is a flow chart of an example process for performing content optimization on content being served to the user device of FIG. 1.

### DETAILED DESCRIPTION OF PREFERRED EMBODIMENTS

The following detailed description refers to the accompanying drawings. The same reference numbers in different drawings may identify the same or similar elements.

Systems and/or methods, described herein, may enable a content distribution system, associated with a service provider network, to obtain content from one or more content providers, to temporarily store the content, and/or to transport the content to a user device in a manner that minimizes utilization of bandwidth, processing, and/or other resources associated with the service provider network. The content distribution system may temporarily store content, obtained from the one or more content providers, that is targeted to a user device. The content may be targeted to the user device based on a type of user device, a location of the user device, usage patterns of the user device, preferred content and/or genres associated with the user device, etc.

As described herein, the content distribution system may perform radio access network (RAN) modeling by monitoring traffic flowing to and/or from the service provider network via the RAN. The RAN modeling may enable the content distribution system to determine whether a condition (e.g., congestion, jitter, packet delay and/or loss, mis-ordered packets, etc.) exists in the RAN. The content distribution system may perform an operation that avoids and/or remedies the condition while ensuring that content, being transported to a user device, is sent in a manner that satisfies a minimum quality of service (QoS).

As also described herein, the content distribution system may monitor incoming and/or outgoing traffic, being carried by the service provider network, to obtain information associated with traffic sent to and/or received from a user device. The content distribution system may use the information associated with the traffic to identify and/or develop a community of interest (COI) associated with the user device. The COI may identify preferred user devices with which the user device communicates, preferred content providers from which the user device and/or other user devices obtain content, preferred content genres associated with the user device and/or other user devices, etc. The content distribution system may use the information, associated with the COI, to assist content providers to target content to the user device and/or the other user devices associated with the COI.

As further described herein, the content distribution system may perform an operation to optimize the content being transported to the user device. The content distribution system may, for example, convert the content into a tailored format that can be easily rendered on a variety of types of user devices. The content distribution system may process the content to ensure that the traffic is optimally configured for transmission to the user device (e.g., converting packets to a maximum transmission unit (MTU), performing packet compression, etc.). The content distribution system may transmit the content at a bandwidth and/or data rate that maximizes throughput and/or ensures a minimum QoS, and/or minimize congestion and/or other network conditions.

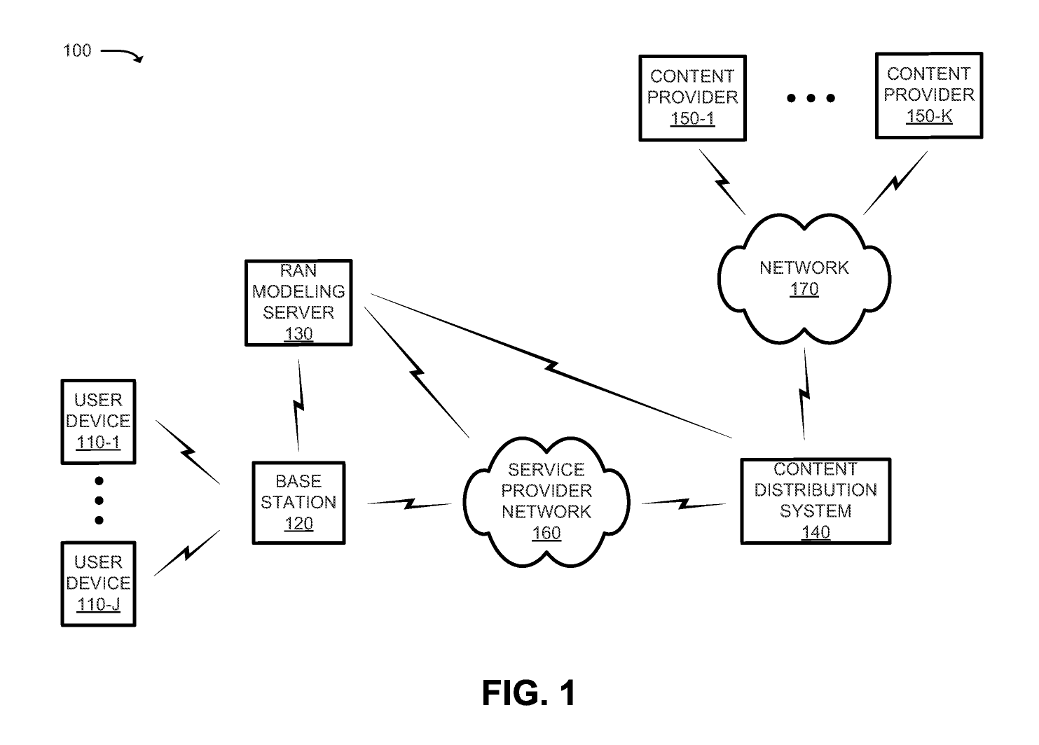

FIG. 1 is a diagram of an example environment 100 in which systems and/or methods described herein may be implemented. As shown in FIG. 1, environment 100 may include a group of user devices 110-1, . . . , 110-J (where J≧1) (hereinafter referred to collectively as “user devices 110” and individually as “user device 110”), a base station 120, a radio access network (RAN) modeling server 130 (hereinafter referred to as “RAN server 130”), a content distribution system (CDS) 140, a group of content providers 150-1, . . . , 150-K (where K≧1) (hereinafter referred collectively as “content providers 150” and individually as “content provider 150”), a service provider network 160 and a network 170. The number of devices, systems, and/or networks, illustrated in FIG. 1, is provided for explanatory purposes only. In practice, there may be additional devices, systems, and/or networks; fewer devices, systems, and/or networks; different devices, systems, and/or networks; or differently arranged devices, systems, and/or networks than illustrated in FIG. 1.

Also, in some implementations, one or more of the devices of environment 100 may perform one or more functions described as being performed by another one or more of the devices of environment 100. For example, RAN server 130 and CDS 140 may be integrated into a single device. Devices and/or systems of environment 100 may interconnect via wired connections, wireless connections, or a combination of wired and wireless connections.

User device 110 may include any computation or communication device, such as a wireless mobile communication device that is capable of communicating with base station 120. For example, user device 110 may include a radiotelephone, a personal communications system (PCS) terminal (e.g., that may combine a cellular radiotelephone with data processing and data communications capabilities), a personal digital assistant (PDA) (e.g., that can include a radiotelephone, a pager, Internet/intranet access, etc.), a laptop computer, a camera, a personal gaming system, a smart phone, or another type of mobile computation or communication device.

Base station 120 may include one or more devices that receive, process, and/or transmit traffic, such as voice, video, text, and/or other data, destined for and/or received from user device 110. One or more base stations 120 may be associated with a RAN that receives traffic from and/or sends traffic to service provider network 160. Base station 120 may send traffic to and/or receive traffic from user device 110 via an air interface and may include one or more cells via which signals are received from and/or transmitted to user device 110.

RAN server 130 may include one or more server devices, or other types of computation or communication devices, that gather, process, search, store, and/or provide information in a manner similar to that described herein. RAN server 130 may, for example, monitor traffic being transported via cells associated with base station 120 to dynamically identify information associated with traffic conditions on base station 120. RAN server 130 may use the information associated with the traffic conditions to determine whether a particular cell, a quantity of cells, and/or base station 120 is congested and/or may become congested at a future point in time. In another example, RAN server 130 may use the information, associated with the traffic conditions, to detect the presence of jitter, dropped and/or delayed packets, mis-ordered packets, and/or other conditions. RAN server 130 may use information associated with traffic profiles to forecast whether a condition may occur at the future point in time. The traffic profiles may be based on historical information associated with traffic conditions that may identify a period of time where traffic load is at a peak level (e.g., during business hours), when traffic load in at a minimum level (e.g., during over night hours), when traffic load is increasing or decreasing, etc.

In one example, RAN server 130 may determine that a condition exists when a bandwidth and/or data rate, associated with the traffic, is greater than a bandwidth threshold and/or data rate threshold, respectively. In another example, RAN server 130 may determine that a condition exists when a quantity of lost packets and/or mis-ordered packets exceeds a lost packet threshold and/or a mis-ordered packet threshold, respectively. In yet another example, RAN server 130 may determine that a conditions exists when information, associated with traffic profiles (e.g., associated with base station 120 and/or a cell associated with base station 120) indicates that the bandwidth and/or data rate, associated with the traffic, is likely to exceed the bandwidth threshold and/or data rate threshold, respectively, at a future point in time. Based on a determination that the condition exists, RAN server 130 may send a notification to CDS 140 that indicates that the condition has been detected. The notification may include a time when the condition was detected or is forecasted to occur and/or information associated with a type of condition. Additionally, or alternatively, the notification may include recommended actions that, when performed by CDS 140, will remedy and/or avoid the condition.

CDS 140 may include one or more devices that gather, process, search, store, and/or provide information in a manner similar to that described herein. CDS 140 may perform operations associated with content distribution within environment 100. For example, CDS 140 may perform caching operations by obtaining content from content provider 150 and temporarily storing the content in a memory associated with CDS 140. CDS 140 may retrieve particular content, from the memory, in response to a request to receive the particular content from user device 110. CDS 140 may receive, from RAN server 130, a notification that a condition has occurred, or is about to occur, within a cell associated with base station 120, and CDS 140 may take corrective action, in response to the notification, such as by transporting content to user device 110 in a manner that remedies, mitigates, or avoids the condition. CDS 140 may process content in order to ensure that the content is sent to user device 110 in a manner that satisfies a QoS threshold. CDS 140 may, for example, convert content into a format and/or protocol based on a type of user device 110. In another example, CDS 140 may process the content by sending the content, to user device 110, at a bandwidth, data rate, and/or packet size that maximizes network throughput without inducing congestion, jitter, and/or other conditions.

CDS 140 may collect analytical and reporting (AR) information associated with traffic being sent to and/or received from user device 110. CDS 140 may, for example, obtain AR information associated with traffic flows between user device 110 and content providers 150, which may include a quantity of communications with each of content providers 150, a type of content associated with the communications, a type of content genre, etc. CDS 140 may obtain AR information associated with communications (e.g., instant message, email, calls, social networking, etc.) between user device 110 and other user devices 110 (e.g., quantity, duration, bandwidth, etc.). CDS 140 may collect AR information associated with network performance when user device 110 communicates with the content providers 150 and/or other user devices 110. CDS 140 may use the collected AR information to ascertain usage behaviors associated with user device 110 and/or to identify a COI associated with user device 110 (e.g., preferred content providers 150, preferred user devices 110, preferred content genres, purchase habits, calling habits, browsing patterns, etc.). CDS 140 may use information associated with the usage behaviors and/or the COI to improve network operations associated with user device 110 and/or to share with content providers 150 (e.g., as a service for a fee) which may enable content providers 150 to target content (e.g., movies, music, products and/or services, advertising, etc.) to user device 110.

Content providers 150 may include any type or form of content providers. For example, content providers 150 may include free television broadcast providers (e.g., local broadcast providers, such as NBC, CBS, ABC, and/or Fox), for-pay television broadcast providers (e.g., TNT, ESPN, HBO, Cinemax, CNN, etc.), and/or Internet-based content providers (e.g., Youtube, Vimeo, Netflix, Hulu, Veoh, etc.) that stream content from web sites and/or permit content to be downloaded (e.g., via progressive download, etc.). Content providers 150 may produce media streams (e.g., television broadcasts). A “media stream,” as used herein, may refer to stream of content that includes video content (e.g., a video stream), audio content (e.g., an audio stream), and/or textual content (e.g., a textual stream).

Service provider network 160 may include one or more wired and/or wireless networks via which user devices 110 communicate and/or receive content. For example, service provider network 160 may include a cellular network, the Public Land Mobile Network (PLMN), a second generation (2G) network, a third generation (3G) network, a fourth generation (4G) network (e.g., a long term evolution (LTE) network), a fifth generation (5G) network, and/or another network. Additionally, or alternatively, service provider network 160 may include a wide area network (WAN), a metropolitan area network (MAN), an ad hoc network, an intranet, a fiber optic-based network (e.g., a fiber optic service (FiOS) network), and/or a combination of these or other types of networks.

Network 170 may include one or more wired and/or wireless networks. For example, network 170 may include a cellular network, the PLMN, a 2G network, a 3G network, a 4G network (e.g., an LTE network), a 5G network, and/or another network. Additionally, or alternatively, network 170 may include a WAN, a MAN, a telephone network (e.g., the Public Switched Telephone Network (PSTN)), an ad hoc network, an intranet, the Internet, a fiber optic-based network (e.g., a FiOS network), and/or a combination of these or other types of networks.

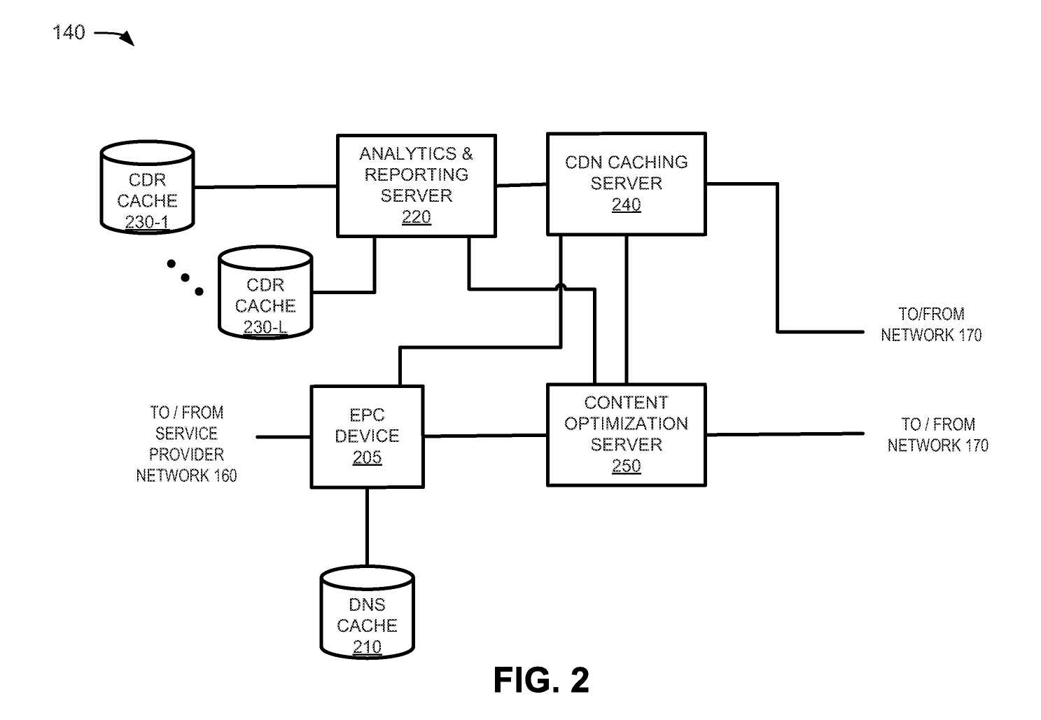

FIG. 2 is a diagram of example devices of CDS 140. CDS 140 may include an embedded packet capture (EPC) device 205, a domain name system (DNS) cache 210, an analytics and reporting (AR) server 220, a group of call data record (CDR) caches 230-1, . . . , 230-L (where L≧1) (hereinafter referred to collectively as “CDR caches 230” and individually as “CDR cache 230”), a content distribution network (CDN) caching server 240, and a content optimization (CO) server 250. Although FIG. 2 shows example devices of CDS 140, in other implementations, CDS 140 may include fewer devices, additional devices, different devices, or differently arranged devices than depicted in FIG. 2. Additionally, or alternatively, one or more devices of CDS 140 may perform one or more tasks described as being performed by one or more other devices of CDS 140.

EPC device 205 may include a network device that, receives, processes, switches, routes, and/or transmits packets associated with traffic being transported to and/or from service provider network 160. For example, EPC device 205 may take the form of a routing device, a switching device (e.g., an Ethernet switch, etc.), a multiplexing device, or a device that performs a combination of routing, switching, and/or multiplexing functions. In one example implementation, EPC device 205 may be a digital device. In another example implementation, EPC device 205 may be an optical device. In yet another example implementation, EPC device 205 may be a combination of a digital device and an optical device.

EPC device 205 may generally function to connect service provider network 160 to CO server 250 and/or network 170. For example, EPC device 205 may transfer traffic, received from user device 110 (e.g., via service provider network 160), to network 170 via CO server 250. In another example, EPC device 205 may receive, from network 170 and via CO server 250, traffic that is destined for user device 110 and EPC device 205 may send the traffic to user device 110 via service provider network 160. EPC device 205 may transfer DNS queries, received from user device 110 via service provider network 160, to DNS cache 210 to obtain an IP address associated with content provider 150 and/or a particular CDN caching server 240 from which content is to be retrieved. EPC device 205 may forward, to CO server 250, the obtained IP address that enables the content to be retrieved from content provider 150 and/or CDN caching server 240.

DNS cache 210 may be a memory device that stores one or more IP addresses for all or a portion of content providers 150 and/or one or more CDN caching servers 240 from which content can be obtained. DNS cache 210 may receive, from user device 110 and via EPC device 205, a request for an IP address associated with particular content (e.g., based on a domain name, etc.) and DNS cache 210 may, in one example, retrieve an IP address, associated with a particular content provider 150, that corresponds to the domain name. DNS cache 210 may send the IP address to user device 110 that enables user device 110 to communicate with the particular content provider 150. In another example, DNS cache 210 may retrieve another IP address associated with a particular CDN caching server 240 in which the particular content is temporarily stored. DNS cache 210 may send the other IP address to user device 110 that enables user device 110 to obtain the particular content from the particular CDN caching server 240.

AR server 220 may include one or more server devices, or other types of computation or communication devices, that gather, process, search, store, and/or provide information in a manner similar to that described herein. In one example implementation, AR server 220 may monitor and/or collect AR information associated with traffic being sent to and/or received from each of user devices 110.

For example, AR server 220 may, based on the monitoring, obtain information associated with user habits of each of user devices 110. AR server 220 may, for example, obtain information associated with a time (e.g., total time, peak time, average time, etc. per second, day, week, etc.) and/or at what cost (e.g., based on minutes used and/or rate per minute, etc.) that a particular user device 110 communicates with one or more content providers 150. AR server 220 may obtain information associated with a quantity of content that is downloaded (e.g., total quantity of bytes per second, week, month, etc.), a quantity of bandwidth used (e.g., total, peak, average, etc. per second, week, month, etc.), and/or a quantity of purchases made (e.g., total, average, etc. per day, week, month, etc.) as a result of communications with the one or more content providers 150.

AR server 220 may obtain information associated with content that is accessed and/or downloaded from the one or more of content providers 150, which may include a method of download (e.g., via streaming media, progressive download, etc.), a type of content (e.g., movies, video, music, audio, games, documents, images, etc.), a genre associated with the content (e.g., sports, science fiction, news, etc.), etc. Based on the information associated with the content, AR server 220 may generate a report that identifies a preferred content provider (e.g., top one, top five, top 10, etc.), a preferred type of content, a preferred genre of content, etc. for user device 110. Additionally, or alternatively, AR server 220 may generate another report that identifies a quantity of content that user device 110 is likely to download, a type of product that user device 110 is likely to purchase, a likelihood that user device 110 may purchase the type of product, etc. AR server 220 generate reports for other user devices 110 and/or may generate an aggregate report for service provider network 160 based on the reports for user device 110 and/or the other user devices 110.

AR server 220 may obtain, from one or more CDR caches 230, information associated with communications (e.g., via instant messages, calls, emails, social networking, etc.) by user devices 110 with which service provider network 160 is associated. AR server 220 may use the information, associated with the communications, to correlate types of communication for each of user devices 110. For example, AR server 220 may obtain, from the information associated with the communications, information associated with a short message service (SMS) CDR in connection with user device 110, a multi-media service (MMS) CDR in connection with user device 110, and/or a mobile switching center (MSC) CDR in connection with user device 110. AR server 220 may use the information associated with the communications to generate a report that identifies preferred user devices 110 (e.g., sometimes referred to as “friends”) with which user device 110 communicates, a preferred method of communicating (e.g., SMS, MMS, calls, etc.) with other user devices 110, and/or information associated with a duration that the communication is likely to be. AR server 220 may generate reports for other user devices 110 and/or for service provider network 160 (e.g., based on an aggregation of the reports associated with user device 110 and/or the other user devices 110).

AR server 220 may monitor flows (e.g., traffic) associated with user devices 110 that are transported via service provider network 160 and may store information, associated with the flows, in a flow data record (FDR) (e.g., within CDR cache 230). The information, associated with the flows, may include information associated with a quantity of concurrent flows (e.g., total, average, peak, etc.), types and/or quantities of IP addresses (e.g., IP version four (IPv4) addresses, IP version six (IPv6) addresses, etc.), a time associated with peak flows, a time associated with peak quantities of each type of IP addresses, a quantity of DNS queries (e.g., from user device 110 to DNS cache 210), information associated with a duration of sessions (e.g., peak, average, minimum, etc.), etc. Additionally, or alternatively, the information associated with the flows may include information associated with data transfer rates (e.g., peak, average, minimum), trends associated with data transfer rates (e.g., increasing, decreasing, etc.), and/or upload to download ratios (e.g., based on a type of user device 110, location, etc.). AR server 220 may generate a report that includes information associated with the flows that originate from user device 110. Additionally, or alternatively, AR server 220 may generate reports for each of the other user devices 110 and/or may generate a report associated with service provider network 160 based on an aggregation of the reports associated with user device 110 and/or the other user devices 110. The reports may be used to monitor performance of CDS 140, identify ways to improve performance, etc.

AR server 220 may collect information associated with network performance based on traffic flowing between user devices 110 and content providers 150. The information associated with the network performance may include information associated with a download time (e.g., peak, average, etc.), a quantity of latency and/or jitter per flow (e.g., peak, average, etc.), a quantity of lost and/or delayed packets (e.g., total, average, peak, etc.), etc.

AR server 220 may identify a COI for user device 110. For example, AR server 220 may correlate AR information associated with user device 110 with AR information associated with preferred user devices 110 with which user device 110 communicates. For example, AR server 220 may correlate user habits, preferred content, preferred content providers 150, etc., associated with user device 110, with user habits, preferred content, preferred content providers 150, etc. associated with preferred user devices 110 to generate information associated with a COI associated with user device 110. AR server 220 may send all or a portion of the information, associated with the COI, to content providers 150 (e.g., as a service for a fee) that permits content providers 150 to send content, to user device 110, in a manner that is tailored and/or customized to the user habits associated with user device 110.

CDR cache 230 may include one or more memory devices that store information, associated with CDRs, that corresponds to user devices 110. For example, CDR cache 230 may store information corresponding to a SMS CDR associated with each of user devices 110. The information, corresponding to the SMS CDR may include information associated with each SMS message (e.g., an originating device identifier, information associated with a manner in which each message is routed, a destination identifier, a bandwidth associated with each message, etc.) that is sent and/or received by each of user devices 110. In another example, CDR cache 230 may store information corresponding to a MMS CDR associated with each of user devices 110. The information, corresponding to the MMS CDR, may include information associated with each multi-media message (e.g., an originating device identifier, information associated with a manner in which each message is routed, a destination device identifier, a bandwidth associated with each message, etc.) that is sent and/or received by each of user devices 110. In yet another example, CDR cache 230 may store information corresponding to an MSC CDR associated with each of user devices 110. The information, corresponding to the MSC CDR, may include information associated with each call (e.g., an originating MDN, information associated with a manner in which each call was routed, a destination MDN, a duration of the call, etc.) that is placed and/or received by each of user devices 110.

CDN caching server 240 may include one or more server devices, or other types of computation or communication devices, that gather, process, search, store, and/or provide information in a manner similar to that described herein. In an example implementation, CDN caching server 240 may perform content caching operations associated with content obtained from content providers 150. For example, CDN caching server 240 may obtain content from one or more content providers 150 and may temporarily store the content in a memory associated with CDN caching server 240. In one example, CDN caching server 240 may send, to a particular content provider 150, a request for updated content at a particular time of day (e.g., during off-peak hours, etc.), at a particular time interval (e.g., every six hours, 12 hours, 24 hours, etc.) and/or at some other time. CDN caching server 240 may send a request for content upon the occurrence of some event. CDN caching server 240 may, for example, send a request for content upon receipt, from the particular content provider 150, of a notification indicating that updated content is available to be downloaded. In another example, CDN caching server 240 may receive a request to retrieve particular content and may determine that the particular content is not stored in the memory. Based on the determination that the particular content is not stored in the memory, CDN caching server 240 may send a request, for the particular content, to a particular content server 150 on which the particular content is hosted.

CDN caching server 240 may process a variety of types of content that is downloaded from content providers 150 (e.g., as streaming media, progressive streaming, progressive download, etc.) for storage by CDN caching server 240. The variety of types of content may include video (e.g., live, On Demand, etc.), audio, images, text, and/or other types of content. CDN caching server 240 may process the variety of types of content by transcoding the content, performing packet compression on packetized data associated with the content, etc.

CO server 250 may include one or more server devices, or other types of computation or communication devices, that gather, process, search, store, and/or provide information in a manner similar to that described herein. In one example implementation, CO server 250 may perform content optimization operations on content being served to user devices 110. For example, CO server 250 may process content, destined for user device 110, to maximize throughput and/or avoid congestion while being transported over service provider network 160 and/or a RAN associated with service provider network 160. CO server 250 may, in another example, process the content to meet a level of QoS specified in a service level agreement (SLA) associated with a particular content provider 150 from which the content originates. CO server 250 may, in yet another example, convert the content to a format, based on a type of user device 110, that enables the content to be received, processed, and/or rendered on user device 110 within a period of time that is less than a threshold.

CO server 250 may perform network access translation (NAT) operations on traffic being sent to and/or received from user device 110. For example, CO server 250 may translate an internal Internet protocol (IP) address (e.g., associated with service provider network 160), obtained from traffic that is received from user device 110, to a corresponding public IP address that can be used by network 170 and/or content providers 150 during a communication session with user device 110. In another example, CO server 250 may translate the public IP address, associated with traffic received from network 170 that is destined for user device 110, to a private IP address that can be used by EPC device 205 and/or service provider network 160 to send the traffic to user device 110. CO server 250 may store, as information associated with NAT bindings, information associated with one or more private IP addresses that are associated with user device 110 in a manner that corresponds to one or more public IP addresses associated with user device 110.

CO server 250 may extract and/or remove information that permits the identity of user device 110 to be determined based on traffic and/or other information that is sent to network 170 and/or content provider 150. For example, CO optimization server may remove and/or extract information, associated with user device 110 (e.g., packets, data contained within packets and/or headers, etc.), included within the traffic being sent to network 170 and/or content provider 150. The information, associated with user device 110, may include an identifier associated with user device 110 (e.g., a mobile directory number (MDN, an electronic serial number (ESN), a subscriber identity module (SIM) universal resource identifier (URI), an international mobile subscriber identifier (IMSI), and/or other identifiers). In another example, CO server 250 may extract and/or remove information associated with a location of user device 110 (e.g., when a user, of user device 110, has not authorized dissemination of the location of user device 110).

CO server 250 may process the content in a number of ways. For example, CO server 250 may process the content, received from CDN caching server 240 and/or content provider 150 by resizing packets, associated with the content. Resizing the packets may enable the content to be more efficiently served to user devices 110. For example, CO server 250 may process the packets in a manner that conforms to a MTU associated with service provider network 160. Processing the packets in the manner that conforms to the MTU may permit the content to be served at a maximum data transfer rate (e.g., greater than a threshold) while avoiding congestion within service provider network 160 and/or a RAN associated with service provider network 160.

CO server 250 may process the packets by performing packet and/or header compression. The packets may be resized and/or compressed to achieve a maximum bandwidth and/or data transfer rate while avoiding congestion and serving the content to user device 110. CO server 250 may accelerate data delivery associated with the content by reducing the quantity of packets associated with transporting and/or serving content to user devices 110. For example, CO server 250 may perform acknowledgement packet thinning by delaying the transport of acknowledgment packets, which may reduce a quantity of redundant acknowledgement packets being transported between service provider network 160 and CO server 250 while sending the content to user device 110.

In another example, CO server 250 may repackage one or more smaller packets into larger packets (e.g., up to the MTU) to increase a transfer data rate and/or bandwidth associated with the content. In yet another example, when lost packets are detected, CO server 250 may use selective acknowledgement packets, that identify packets that were received from content provider 150, which informs content provider 150 to resend only those packets identified as missing.

CO server 250 may use one or more application programming interfaces (APIs) that permit CO server 250 to receive location-based services (LBS) from service provider network 160. For example, CO server 250 may use an API, associated with the LBS (hereinafter referred to as an “LBS API”), to obtain, from service provider network 160, information associated with a location of user devices 110. The information associated with a location may include information associated with latitude and/or longitude information, a grid location, a geographic area, an address, etc., associated with each of user devices 110. CO server 250 may send the location information, associated with all or a portion of user devices 110, to content providers 150 with which a SLA has been executed (e.g., if authorized by users of user devices 110). CO server 250 may not send the information, associated with the location, to content providers 150 for which a SLA has not been executed and/or for user devices 110 with users that have not authorized (e.g., that have opted-out) the dissemination of the location information.

CO server 250 may reduce processing time associated with user devices 110 for which content is being served. For example, CO server 250 may convert content, received from CDN caching server 240 and/or content provider 150, into a format that can easily be received, processed, and/or rendered on user device 110. CO server 250 may, for example, use information associated with a type of user device 110 (e.g., a model identifier, information associated with an operating system being used by user device 110, etc.) to convert the received content into the format that causes a time, associated with mobile page rendering on user device 110, to be reduced (e.g., below a threshold). CO server 250 may identify user device 110 based on NAT bindings (e.g., described above with respect to EPC device 205) and may obtain information, associated with the type of user device 110, from information associated with a user profile for user device 110 (e.g., from a home subscriber server (HSS) associated with service provider network 160).

CO server 250 may cause content to be served to user device 110 in a manner that minimizes and/or avoids conditions present on a RAN associated with service provider network 160. For example, CO server 250 may receive a notification, from RAN modeling server 130, that indicates that a condition exists, or is forecasted to exist, within one or more cells associated with base station 120. The notification may indicate that streaming video (e.g., being received by one or more user devices 110 via a cell associated with base station 120), is associated with a data transfer rate that is causing, or is forecasted to cause, congestion within the cell. CO server 250 may, in response to the notification, send an instruction, to EPC device 205, indicating that data transfer rates, associated with the video stream and/or other media streams being transported via the cell, are to be reduced below a particular data rate threshold. The particular data rate threshold may be determined, by CO server 250 and/or RAN modeling server 130, in a manner that reduces and/or remedies the congestion while maintaining a QoS, associated with the video stream and/or the other media streams (e.g., greater than a QoS threshold).

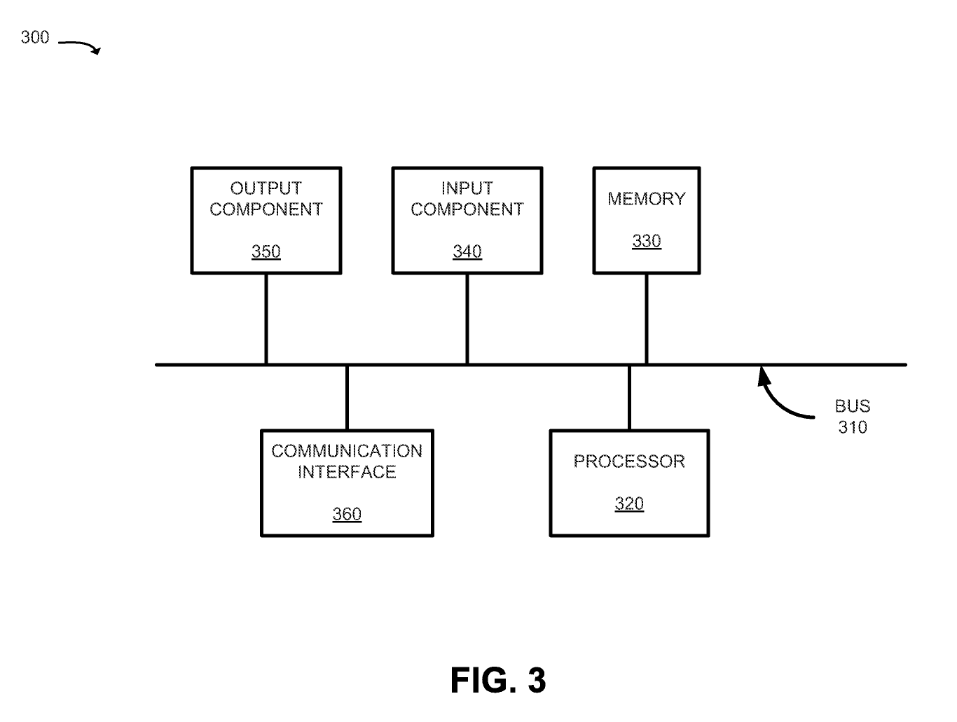

FIG. 3 is a diagram of example components of a device 300 that may correspond to user device 110, RAN modeling server 130, EPC device 205, AR server 220, CDN caching server 240, and/or CO server 250. Alternatively, each of user device 110, RAN modeling server 130, EPC device 205, AR server 220, CDN caching server 240, and/or CO server 250 may include one or more devices 300. Device 300 may include a bus 310, a processor 320, a memory 330, an input component 340, an output component 350, and a communication interface 360. Although FIG. 3 shows example components of device 300, in other implementations, device 300 may contain fewer components, additional components, different components, or differently arranged components than depicted in FIG. 3. For example, device 300 may include one or more switch fabrics instead of, or in addition to, bus 310. Additionally, or alternatively, one or more components of device 300 may perform one or more tasks described as being performed by one or more other components of device 300.

Bus 310 may include a path that permits communication among the components of device 300. Processor 320 may include a processor, microprocessor, or processing logic that may interpret and execute instructions. Memory 330 may include any type of dynamic storage device that may store information and instructions, for execution by processor 320, and/or any type of non-volatile storage device that may store information for use by processor 320.

Input component 340 may include a mechanism that permits a user to input information to device 300, such as a keyboard, a keypad, a button, a switch, etc. Output component 350 may include a mechanism that outputs information to the user, such as a display, a speaker, one or more light emitting diodes (LEDs), etc. Communication interface 360 may include any transceiver-like mechanism that enables device 300 to communicate with other devices and/or systems via wireless communications (e.g., radio frequency, infrared, and/or visual optics, etc.), wired communications (e.g., conductive wire, twisted pair cable, coaxial cable, transmission line, fiber optic cable, and/or waveguide, etc.), or a combination of wireless and wired communications. For example, communication interface 360 may include mechanisms for communicating with another device or system via a network, such as service provider network 160 and/or network 170. In one alternative implementation, communication interface 360 may be a logical component that includes input and output ports, input and output systems, and/or other input and output components that facilitate the transmission of data to other devices.

As will be described in detail below, device 300 may perform certain operations relating operations associated with a content distribution network. Device 300 may perform these operations in response to processor 320 executing software instructions contained in a computer-readable medium, such as memory 330. A computer-readable medium may be defined as a non-transitory memory device. A memory device may include space within a single physical memory device or spread across multiple physical memory devices. The software instructions may be read into memory 330 from another computer-readable medium or from another device. The software instructions contained in memory 330 may cause processor 320 to perform processes described herein. Alternatively, hardwired circuitry may be used in place of or in combination with software instructions to implement processes described herein. Thus, implementations described herein are not limited to any specific combination of hardware circuitry and software.

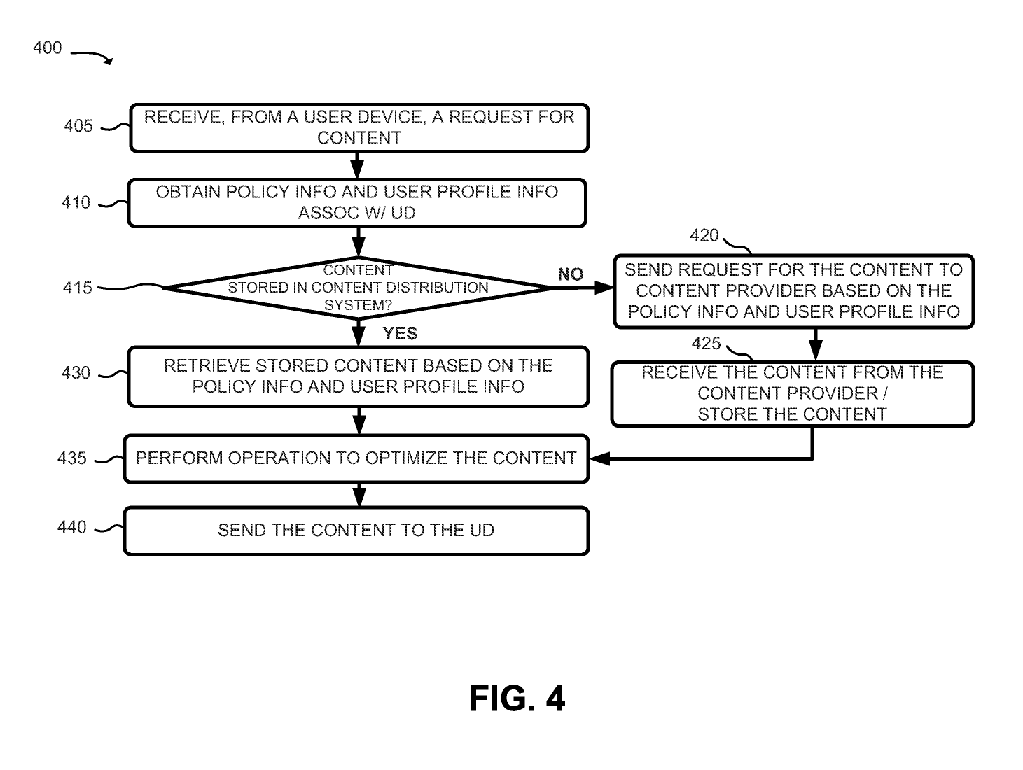

FIG. 4 is a flow chart of an example process 400 for storing content according to an implementation described herein. In one example implementation, process 400 may be performed by CDS 140. In another example implementation, some or all of process 400 may be performed by a device or collection of devices separate from, or in combination with, CDS 140.

As shown in FIG. 4, process 400 may include receiving, from user device 110, a request for content (block 405). For example, a user, of user device 110, may send a request for content hosted by content provider 150. CDS 140 may receive the request and may determine from which user device 110, the request is received based on information associated with user device 110, such as a network address used by service provider network (e.g., an IP address, etc.), a device identifier (e.g., an MDN, an IMSI, SIM URI, etc.).

As also shown in FIG. 4, process 400 may include obtaining policy information and/or information, associated with a user profile, associated with user device 110 (block 410). For example, CDS 140 may retrieve, in response to the request, policy information associated with service provider network 160 (e.g., from a policy server, such as a policy charging and rules function (PCRF) server associated with service provider network 160) and/or information associated with a user profile (e.g., from an HSS associated with service provider network 160). CDS 140 may use the information, associated with the user profile, to determine whether user device 110 authorizes location information and/or other information, associated with user device 110, to be disseminated to network 170 and/or content provider 150. Additionally, or alternatively, CDS 140 may use the policy information to determine whether a SLA, associated with content provider 150, has been executed. If, for example, the SLA is determined to have been executed, then CDS 140 may identify whether content, associated with content provider 150, is stored (e.g., by CDN caching server 240) in a memory associated with CDS 140 and/or whether the content is to be served to user device 110 based on a QoS level specified by the SLA.

As further shown in FIG. 4, if the content is not stored in CDS 140 (block 415—NO) then process 400 may include sending, to content provider 150, a request for the content based on the policy information and/or information associated with the user profile (block 420). For example, CDS 140 may identify that a SLA, associated with content provider 150, has not been executed based on the policy information associated with service provider network 160. Based on the identification that the SLA has not been executed, CDS 140 may determine that the content is not being temporarily stored by CDS 140 and/or may send a request, to content provider 150, for the content. In another example implementation, if a quantity of requests for the content, hosted by content provider 150 for which a SLA has not been established, then CDS 140 may send a notification that includes a recommendation that a SLA is to be executed with content provider 150, which may enable CDS 140 to temporarily store the content.

In another example, CDS 140 may send, to content provider 150 (e.g., with which the SLA has been established), a request (e.g., a hyper text transfer protocol (HTTP) HEAD request and/or some other request) for information associated with the content that is hosted by content provider 150. Content provider 150 may receive the request and may send a response (e.g., a HTTP HEAD response and/or some other response) that includes the information associated with the content (e.g., a date, a version, an identifier, a quantity of data associated with the content, etc.). CDS 140 may receive the information associated with the content and may compare the information associated with the content to information associated with the content stored by CDS 140 to determine whether the received information, associated with the content, matches the stored information associated with the content. Based on a determination that the received information, associated with the content, does not match the stored information, associated with the content, CDS 140 may send a request (e.g., a HTTP GET request and/or some other request), to content provider 150, to obtain the content. In another example implementation, CDS 140 may automatically send the request for content (e.g., new content and/or updated content) at a particular time (e.g., a particular time of day), periodically (e.g., based on a time interval, such as every six hours, 12 hours, 24 hours, etc.), etc.

The request to obtain the content may include information associated with a location of the user device 110, based on a determination that the information associated with the user profile indicates that user device 110 authorizes dissemination of the information associated with the location of user device 110. The information associated with the location of user device 110 may permit content provider 150 to provide the content in a manner that is customized for the user device 110. The information, associated with the location of user device 110, may be obtained, from service provider network 160, using an LBS API that permits CDS 140 to obtain information, associated with a location for user devices 110, from service provider network 160. If the information, associated with the user profile, indicates that user device 110 does not authorize the dissemination of the information, associated with the location, CDS 140 may send the request in a manner that does not include the information associated with the location of user device 110.

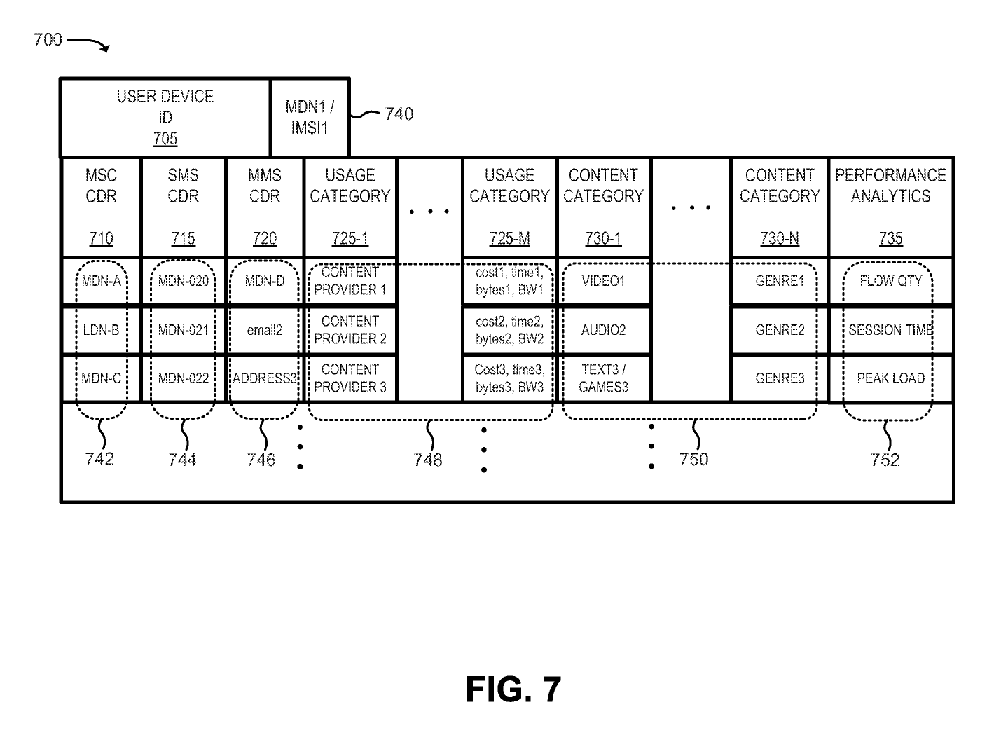

As yet further shown in FIG. 4, process 400 may include receiving the content from content provider 150 and storing the content (block 425). For example, content provider 150 may receive the request and may, in response to the request, send the content to CDS 140. In one example, the content may be tailored for user device 110 based on the information, associated with a location of user device 110. In another example, the content may not be tailored for user device 110 when the information, associated with the location of user device 110, was not included in the request from CDS 140. In another example implementation, the content may be tailored to user device 110 based on information, associated with a COI associated with user device 110 (e.g., discussed in greater detail below in with respect to FIGS. 7-9). CDS 140 may receive the content and may temporarily store the content (e.g., in a memory associated with CDN caching server 240).

As still further shown in FIG. 4, if the content is stored in CDS 140 (block 415—YES) then process 400 may include retrieving the stored content based on the policy information and/or the information associated with the user profile (block 430). For example, CDS 140 may determine that the content has been temporarily stored (e.g., by CDS caching server 240) when information associated with the content (e.g., obtained via a HTTP HEAD response) matches the stored information associated with the content. Based on a determination that the received information, associated with the content, matches the stored information, associated with the content, CDS 140 may retrieve the content (e.g., from CDS caching server 240).

In one example, the retrieved content may be tailored and/or customized, for user device 110, based on the information, associated with the location of user device 110, obtained from service provider network 160 (e.g., using the LBS API) in a manner similar to that described above (e.g., with respect to block 410). In another example implementation, the retrieved content may be tailored to user device 110 based on information, associated with a COI associated with user device 110 (e.g., as discussed in greater detail below in with respect to FIGS. 7-9).

As shown in FIG. 4, process 400 may include performing an operation to optimize the content (block 435) and sending the optimized content to user device 110 (block 440). For example, CDS 140 (e.g., CO server 250) may process the packets by performing packet and/or header compression. The packets and/or headers may be compressed to achieve a maximum bandwidth and/or data transfer rate while avoiding congestion when serving the content to user device 110. CDS 140 may accelerate delivery of the content by reducing packet count associated with transporting and/or serving the content to user device 110. For example, CDS 140 may delay the transport of acknowledgment packets, which may reduce a quantity of redundant acknowledgement packets being transported while serving the content. In another example, CDS may configure packets, associated with the content, into larger packets (e.g., up to the MTU) to increase a data transfer rate and/or bandwidth associated with the content. In yet another example, when lost packets are detected, CO server 250 may use selective acknowledgements, that identify those packets that were received from content provider 150, which may instruct content provider 150 to resend only packets identified as missing rather than resending all or a portion of received packets associated with a flow with which missing packets have been detected.

CDS 140 may process the content in a manner that enables user device 110 to receive, process, and/or render the content within a period of time that is less than a threshold. For example, CDS 140 may convert the content into a tailored and/or customized format that enables user device 110 to receive, process, and/or render the content in a reduce period of time. CDS 140 may, for example, retrieve information associated with a type of user device 110 (e.g., a model identifier, information associated with an operating system being used by user device 110, etc.) from service provider network 160 (e.g., from a HSS associated with service provider network). CDS 140 may use the information, associated with a type of user device 110, to convert the content into a format that causes a time, associated with content page rendering on user device 110, to be reduced (e.g., to less the threshold).

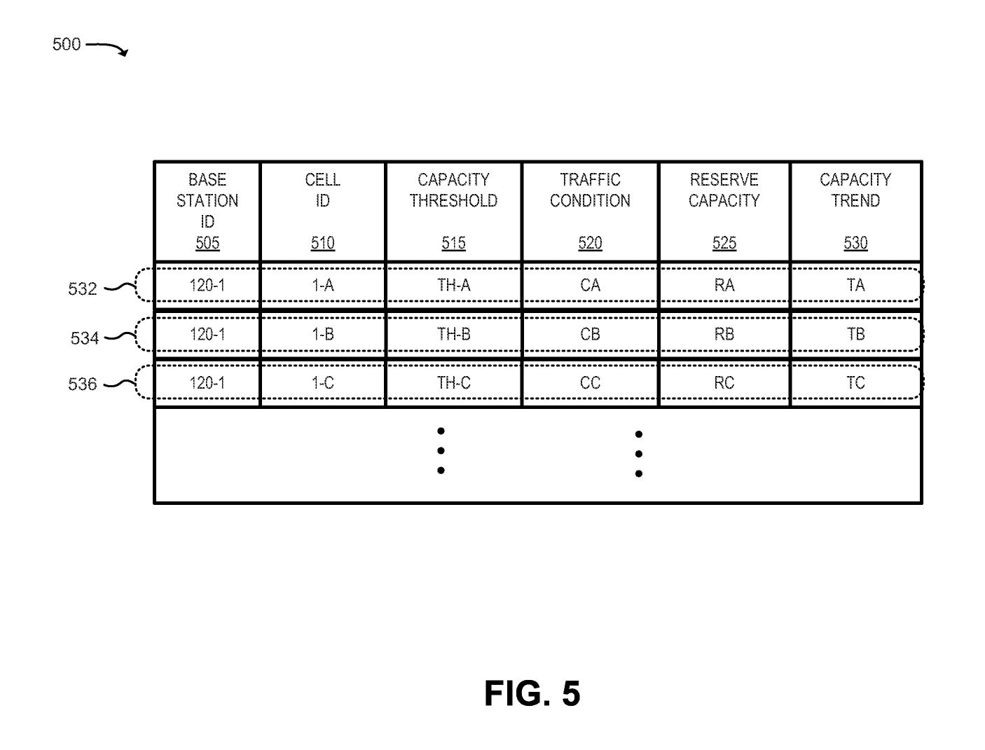

FIG. 5 is a diagram of an example data structure 500 that stores information, associated with traffic conditions within base station 120, according to an implementation described herein. RAN server 130 may monitor traffic flows being transported via one or more cells associated with base station 120 and/or may collect information, associated with the monitoring of the one or more flows, for storage in data structure 500. Data structure 500 may include a collection of fields, such as a base station identifier (ID) field 505, a cell identifier (ID) field 510, a capacity threshold field 515, a traffic condition field 520, a reserve capacity field 525, and a capacity trend field 530. Data structure 500 includes fields 505-530 for explanatory purposes. In practice, data structure 500 may include additional fields, fewer fields, different fields, and/or differently arranged fields than are described with respect to data structure 500.

Base station ID field 505 may store information associated with base station 120 with which one or more cells are associated. Cell ID field 510 may store information associated with a particular cell, associated with base station 120, via which user device 110 communicates with service provider network 160. Capacity threshold field 515 may store information associated with a maximum quantity of traffic (e.g., a maximum bandwidth, data transfer rate, etc.) that can be processed and/or transported without the particular cell becoming congested. Traffic condition field 520 may store information associated with a traffic load and/or traffic condition that corresponds with the particular cell. For example, RAN server 130 may store information associated with a traffic load (e.g., bandwidth and/or data transfer rate) being transported via the particular cell at a particular point in time. In another example, RAN server 130 may store information, associated with a traffic condition (e.g., as an indication that congestion, jitter, lost packets, delayed packets, mis-ordered packets, etc. have been detected) in connection with traffic being transported via the particular cell.

Reserve capacity field 525 may store information associated with a quantity of reserve traffic capacity associated with the particular cell. For example, RAN server 130 may identify the quantity of reserve traffic capacity based on a difference between the traffic load being transported via the particular cell and a capacity threshold associated with the cell (e.g., according to R=TH−L, where R corresponds to the reserve capacity, TH corresponds to the capacity threshold, and L corresponds to the traffic load). RAN server 130 may determine that congestion is present when the reserve capacity is less than a reserve capacity threshold associated with the particular cell. Trend field 530 may store information associated with whether the quantity of reserve capacity is increasing, decreasing, or not changing as a function of time.

RAN server 130 may monitor traffic being transported via one or more cells associated with base station 120 and may store information, associated with conditions of each cell, in data structure 500. For example, RAN server 130 may store information associated with base station 120 (e.g., 120-1) and/or an identifier associated with a cell (e.g., 1-A) associated with base station 120 (e.g., shown as ellipse 532). RAN server 130 may store information, associated with a maximum quantity of traffic that the cell can transport without being congested (e.g., TH-A) (e.g., as shown as ellipse 532). RAN server 130 may monitor a load condition associated with the cell and may store, in data structure 500, information associated with a bandwidth and/or data transfer rate (e.g., CA) associated with the traffic (e.g., as shown by ellipse 532). RAN server 130 may determine a reserve capacity, associated with the cell, based on the reserve capacity and/or the traffic load, and may store information associated with the reserve capacity (e.g., RA) in data structure 500. RAN server 130 may compare the information associated with the reserve capacity, at a current point in time with information associated with the reserve capacity at a prior point in time to determine whether the reserve capacity, associated with the particular cell, is increasing, decreasing, or not changing. RAN server 130 may store, in data structure 500, an indication (e.g., TA) regarding whether the reserve capacity, associated with the particular cell, is increasing, decreasing, or not changing (e.g., as shown by ellipse 532).

RAN server 130 may store other information associated with conditions on other cells associated with base station 120 (e.g., as shown by ellipses 534 and 536). RAN server 130 may use the information, stored in data structure 500, to identify a condition associated with a cell that serves user device 110 (e.g., when reserve capacity is less than a reserve capacity threshold, when jitter is detected, and/or when one or more packets are lost, delayed, and/or mis-ordered). RAN server 130 may send a notification, to CDS 140, that the condition, associated with the cell, has been detected.

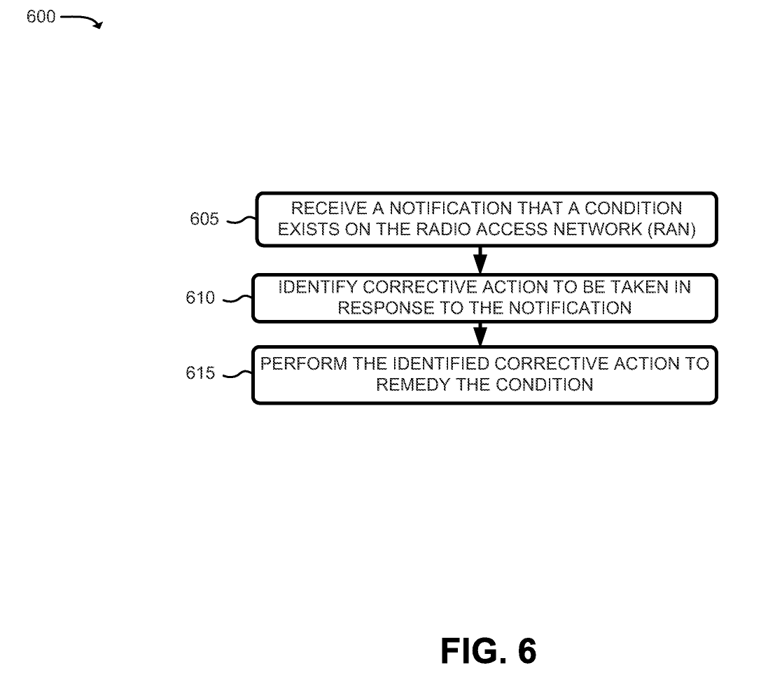

FIG. 6 is a flow chart of an example process 600 for optimizing a manner in which content is served based on a condition being detected on a RAN associated with service provider network 160. In one example implementation, process 600 may be performed by CDS 140 and/or RAN server 130. In another example implementation, some or all of process 600 may be performed by a device or collection of devices separate from, or in combination with, CDS 140 and/or RAN server 130.

As shown in FIG. 6, process 600 may include receiving a notification that a condition exists within a RAN (block 605). For example, RAN server 130 may monitor traffic being transported via one or more base stations 120. RAN server 130 may, based on the monitoring, determine that a condition exists on a cell associated with base station 120. For example, RAN server 130 may, in a manner similar to that described in FIG. 5, determine that a reserve capacity, associated with the cell, is less than a reserve capacity threshold and may determine that a condition (e.g., congestion) exists with respect to the cell. In another example, RAN server 130 may determine that the reserve capacity, associated with the cell, is not less than the reserve capacity threshold, but may forecast that the reserve capacity will be less than the reserve capacity threshold, at a future point in time, based on historical information associated with traffic load in connection with the cell and/or a trend that indicates that the reserve capacity is decreasing. Based on the determination that the reserve capacity may be less than the reserve capacity threshold, at the future point in time, RAN server 130 may determine that a condition exists with respect to the cell. In yet another example, RAN server 130 may detect jitter and/or that a quantity of lost, delayed, and/or mis-ordered packets exceeds a threshold. Based on the detection of jitter and/or that the quantity of lost, delayed, and/or mis-ordered packets exceeds the threshold, the RAN server 130 may determine that a condition exists in connection with the cell. Based on the determination that a condition exists, RAN server 130 may send a notification to CDS 140 indicating that the condition exists in connection with the cell. The notification may include information associated with base station 120 with which the cell is associated, information associated with the cell, and/or information associated with the condition. Additionally, or alternatively, the notification may include information associated with a recommended corrective action that, if executed by CDS 140, remedies, avoids, and/or reduces the effects of the condition on the RAN. CDS 140 may receive the notification that the condition has been detected.

As also shown in FIG. 6, process 600 may include identifying a corrective action to be taken in response to the notification (block 610). For example, CDS 140 may initiate an operation that corresponds to the recommended corrective action obtained from the notification. In another example, CDS 140 may identify a corrective action to be taken based on a type of condition identified in the notification. The corrective action may be performed in a manner that does not change the content associated with the traffic being transported by the cell.

For example, the corrective action may include reducing a traffic load associated with the cell (e.g., based on the recommended corrective action and/or the identified corrective action) in a manner that increases a reserve capacity to a level that is greater than a threshold, which may avoid, mitigate, and/or eliminate the condition (e.g., by removing congestion and/or jitter associated with the cell, by reducing or eliminating a quantity of lost, delayed, and/or mis-ordered packets being detected, etc.). In another example, the corrective action may be to reduce a traffic load at a particular point in time in response to a condition that is forecasted to occur. In another example, transmission of non-essential packets (e.g., packets not associated with content and/or core services associated with service provider network 160) may be delayed and/or dropped.

As further shown in FIG. 6, process 600 may include performing the identified corrective action to remedy the condition (block 615). For example, CDS 140 may cause a data transfer rate associated with one or more video streams, being served via the cell, to be reduced to a particular level that is below a threshold. Reducing the data transfer rate to the particular level may cause the traffic load, associated with the cell, to decrease (e.g., below a capacity threshold associated with the cell) and/or may remedy the condition. The reduction in the data transfer rate, associated with the one or more video streams, may be executed in a manner that does not remove content and/or does not cause noticeable performance degradation from a point of view of a user of user device 110. In another example, CDS 140 may cause particular traffic, which is being transported at a data transfer rate that is greater than a data transfer rate specified in a SLA (e.g., that corresponds to content provider 150), to be transmitted at a another data transfer rate (e.g., that conforms to the SLA). Transmitting the particular traffic at the other data transfer rate may cause the traffic load associated with the cell to decrease (e.g., below the capacity threshold), which may remedy the condition.

FIG. 7 is a diagram of an example analytics and reporting data structure 700 (hereinafter referred to as “AR data structure 700”) that stores analytics and reporting (AR) information associated with content, usage patterns, and/or network performance associated with user device 110. AR data structure 700 may include a collection of fields, such as a user device identifier (ID) field 705, a mobile switching center (MSC) call data record (CDR) field 710, a short message service (SMS) call data record (CDR) field 715, a multi-media service (MMS) call data record (CDR) field 720, a group of usage category fields 725-1, . . . , 725-M (where M≧1), a group of content category fields 730-1, . . . , 730-N (where N≧1), and a performance analytics field 735. AR data structure 700 includes fields 705-735 for explanatory purposes. In practice, AR data structure 700 may include additional fields, fewer fields, different fields, and/or differently arranged fields than are described with respect to AR data structure 700.

User device ID field 705 may store information associated with a particular user device 110. The information, associated with the particular user device 110, may include an identifier (e.g., a MDN, an IMSI, a SIM URI, etc.). MSC CDR field 710 may store information associated with calls to and/or from the particular user device 110. For example, information, associated with a call may include information associated with another user device 110 with which the particular user device 110 is communicating (e.g., another MDN, LDN, etc.), information associated with a manner in which the call was routed, a time associated with the call, a duration associated with the call, etc. SMS CDR field 715 may store information associated with messages (e.g., SMS messages) sent to or from the particular user device 110. For example, the information, associated with a message may include information associated with another user device 110 with which the particular user device 110 was communicating (e.g., another MDN, LDN, a network address, etc.), information associated with a manner in which the message was routed, a time associated with the message, a quantity of bytes associated with the message, etc. MMS CDR field 720 may store information associated with multi-media messages (e.g., MMS messages) sent to and/or from the particular user device 110. For example, information, associated with a multi-media message may include information associated with another user device 110 with which the particular user device 110 was communicating (e.g., another MDN, LDN, address, etc.), information associated with a manner in which the multi-media message was routed, a time associated with the multi-media message, a quantity of bytes associated with the multi-media message, etc.

Usage category field 725 may store AR information associated with user habits that correspond to the particular user device 110. For example, CDS 140 may store, in usage category field 725, information associated with a cumulative time (e.g., total time, peak time, average time, etc. per second, day, week, etc.) and/or a cost (e.g., based on minutes used and/or rate per minute, etc.) that a particular user device 110 communicates with each of content providers 150. CDS 140 may store information associated with a quantity of content that is downloaded (e.g., bytes per second, week, month, etc.), a quantity of bandwidth and/or a data transfer rate used to download the content (e.g., total, peak, average, etc. per second, week, month, etc.), times of day when user device 110 is receiving content, etc. as a result of communications with each of content providers 150.

Content category field 730 may store AR information associated with content that has been served to the particular user device 110. For example, CDS 140 may store, in content category field 730, information associated with a type of content (e.g., movies, video, music, audio, games, documents, images, etc.), a genre associated with the content (e.g., sports, science fiction, news, etc.), and/or purchases of goods and/or services (e.g., total, average, etc. per day, week, month, etc.) obtained from each of content providers 150. In another example, CDS 140 may sort the information associated with the content based on a quantity of times that the particular user device 110 accesses, downloads, and/or purchases content associated with each genre, each type of content, and/or one or more types of goods and/or services from each content provider 150. Based on the sorting of the information, CDS 140 may identify one or more preferred content providers 150 (e.g., top one, time five, top 10, etc.), one or more preferred types of content (e.g., top one, time five, top 10, etc.), and/or one or more preferred content genres (e.g., top one, time five, top 10, etc.) associated with the particular user device 110.

Performance analytics field 735 may store AR information corresponding to performance of service provider network 160 when serving content to the particular user device 110. For example, CDS 140 may store, in performance analytics field 735, information associated with a quantity of flows (e.g., total, average, peak, etc. per day, week, month, etc.) associated with the particular user device 110, types and/or quantities of IP addresses used during communications (e.g., IPv4 addresses, IPv6 addresses, etc.) associated with the particular user device 110, a quantity of DNS queries (e.g., from user device 110 to DNS cache 210), and/or information associated with a duration of communications (e.g., peak, average, minimum, etc.) in connection with the particular user device 110.

CDS 140 may store, in performance analytics field 735, information associated with data transfer rates (e.g., peak, average, minimum), trends associated with data transfer rates (e.g., increasing, decreasing, etc.), and/or upload to download ratios (e.g., based on a type of the particular user device 110, location, etc.). Additionally, or alternatively, CDS 140 may store, in performance analytics field 735, information associated with a quantity of latency and/or jitter per flow (e.g., peak, average, etc.), a quantity of lost and/or delayed packets (e.g., total, average, peak, etc.) etc. in connection with the particular user device 110 when communicating to content providers 150.

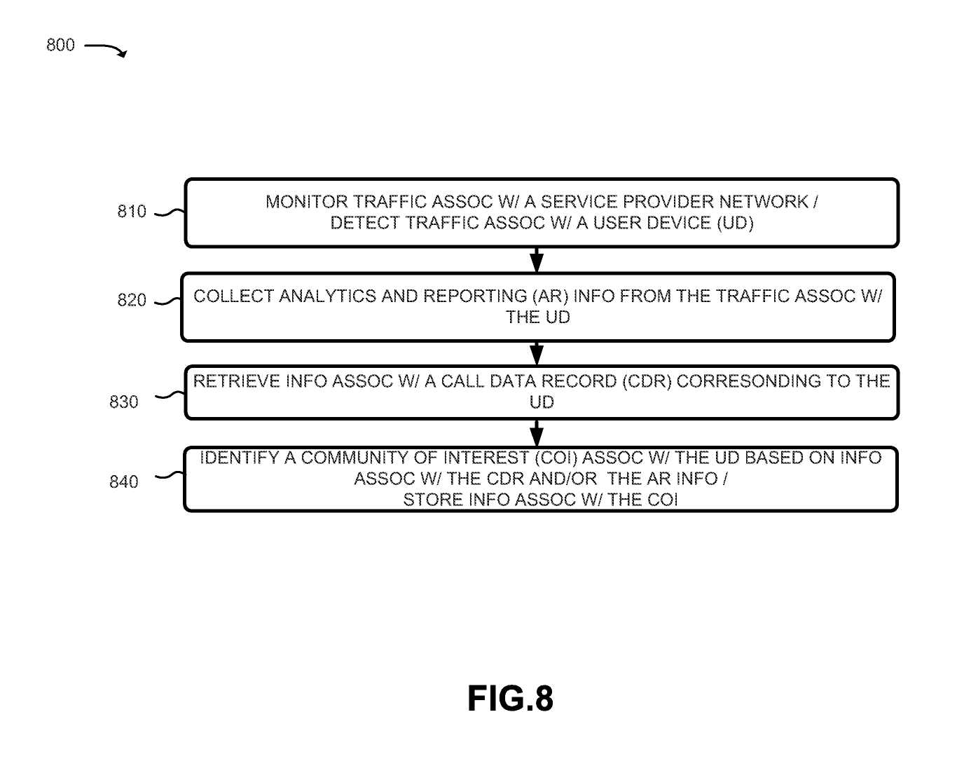

CDS 140 may monitor traffic flows associated with user device 110 and may collect AR information, associated with user device 110 (e.g., shown as MDN1/IMSI 740), for storage in AR data structure 700. The AR information (e.g., as shown by ellipses 742 through 752) will be discussed in detail below (e.g., with respect to FIG. 8).

FIG. 8 is a flow chart of an example process 800 for performing an operation to obtain AR information and/or to identify a COI associated with user device 110. In one example implementation, process 800 may be performed by CDS 140. In another example implementation, some or all of process 800 may be performed by a device or collection of devices separate from, or in combination with, CDS 140.

As shown in FIG. 8, process 800 may include monitoring traffic associated with service provider network 160 and detecting traffic associated with user device 110 (block 810). For example, CDS 140 (e.g., AR server 220) may monitor traffic being transported to and/or from service provider network 160 to collect AR information associated with service provider network 160. CDS 140 may detect traffic associated with user device 110 based on the monitoring of traffic being transported to and/or from service provider network 160 and may store information, associated with user device (e.g., as shown by MDN1/IMSI1 740 of FIG. 7). The traffic, associated with user device 110, may be associated with content that is being received from one or more content providers 150 and/or retrieved from a memory associated with CDS 140.

As also shown in FIG. 8, process 800 may include collecting AR information from the traffic associated with user device 110 (block 820). For example, CDS 140 may collect, from the traffic associated with the user device 110, information corresponding to user habits of user device 110, information associated with the content served to user device 110, and/or information associated with performance analytics associated with user device 110. For example, the information corresponding to the user habits may include information associated with content providers 150 from which user device 110 receives content (e.g., content provider 1, content provider 2, content provider 3, etc. as shown by ellipse 748 of FIG. 7). In another example, the information corresponding to the user habits may include information associated with a quantity of time (e.g., time1, time2, time3, etc.) and/or cost (e.g., cost1, cost 2, cost3, etc.) that user device 110 communicates with each of content providers 150 (e.g., as shown by ellipse 748). In yet another example, the information corresponding to the user habits may include a quantity of content that is downloaded (e.g., byte1, byte2, byte3, etc.), a quantity of bandwidth and/or a data transfer rate used to download the content (e.g., BW1, BW2, BW3, etc.), and/or other information associated with the user habits (e.g., as shown by ellipse 748).

The information associated with the content, served to user device 110, may include information associated with a type of content (e.g., video1, audio2, text3/games3,etc.) and/or a genre associated with the content (e.g., genre1, genre2, genre3, etc.) obtained from each of content providers 150 (e.g., as shown by ellipse 750 of FIG. 7). In another example, the information associated with the content may include information associated with one or more purchases of goods and/or services, a quantity of times that the content (e.g., associated with one or more genres) is received, and/or a quantity of times that the content (e.g., associated with one or more types of content, etc.) is received by user device 110 as a result of communications with each of content providers 150.

As further shown in FIG. 8, process 800 may include retrieving information associated with a CDR from a memory associated with CDS 140 (block 830). For example, CDS 140 may retrieve, from a memory associated with CDS 140 (e.g., CDR cache 230), information associated with a CDR associated with user device 110. For example, CDS 140 may retrieve, from an MSC CDR, information associated with calls placed to and/or by user device 110. The information associated with the calls may include information associated with other user devices 110 (e.g., MDN-A, LDN-B, MDN-C, etc, as shown by ellipse 742 of FIG. 7) that were called and/or called by user device 110, a time associated with each call, a duration of each call, etc.

In another example, CDS 140 may retrieve, from an SMS CDR, information associated with messages (e.g., text messages, etc.) sent from and/or received by user device 110. The information associated with the messages may include information associated with other user devices 110 (e.g., MDN-020, MDN-021, MDN-022, etc., as shown by ellipse 744 of FIG. 7) with which messages were exchanged, a time associated with each message, a quantity of bytes associated with each message, etc. In yet another example, CDS 140 may retrieve, from an MMS CDR, information associated with multi-media messages (e.g., MMS messages, etc.) sent from and/or received by user device 110. The information associated with the multi-media messages may include information associated with other user devices 110 (e.g., MDN-D, email2, IP address3, etc., as shown by ellipse 746 of FIG. 7) with which multi-media messages were exchanged, a time associated with each multi-media message, a quantity of bytes associated with each multi-media message, etc.

In another example implementation, CDS 140 may obtain AR information, associated with the CDR (e.g., that corresponds to user device 110), based on the monitoring of the traffic associated with user device 110 instead of, or in addition to, the memory associated with CDS 140.

As yet further shown in FIG. 8, process 800 may include identifying a COI associated with user device 110 based on information associated with the CDR and/or the AR information and storing the information associated with the COI (block 840). For example, CDS 140 may process the information, associated with the CDR, to identify preferred user devices 110 with which user device 110 communicates most frequently (e.g., based on a threshold). CDS 140 may, for example, generate an ordered list of other user devices 110 based on a quantity of messages, calls, emails, etc. (e.g., obtained from the information associated with the CDR) that have been exchanged between user device 110 and the other user devices 110. CDS 140 may use the ordered list of other user devices 110 to identify the preferred user devices 110 (e.g., a top one, top five, top 10, etc.) based on a respective ranking for each of the other user devices 110. The preferred user devices 110 may sometimes be referred to as “friends” of user device 110 and the collection of friends may be referred to as a “community” associated with user device 110.

CDS 140 may process the AR information, associated with user device 110, to identify preferred content providers 150 from which user device 110 obtains content. CDS 140 may, for example, generate an ordered list of content providers 150 based on a quantity of times user device 110 communicates with each of content providers 150, a quantity of content downloaded from each of content providers 150, a quantity of purchases may from each of content providers 150, etc. CDS 140 may use the ordered list of content providers 150 to identify the preferred content providers 150 (e.g., a top one, top five, top 10, etc.) based on a respective order for each of content providers 150.

CDS 140 may process the AR information, associated with user device 110, to identify preferred content, content genres, content types, etc. associated with user device 110. CDS 140 may, for example, generate an ordered list of content based on a quantity of times user device 110 has downloaded, purchased, accessed, etc. respective items of content from content providers 150. CDS 140 may use the ordered list of content to identify the preferred content (e.g., a top one, top five, top 10, etc.) based on a respective ranking of each item of content. Additionally, or alternatively, CDS 140 may identify preferred content genres (e.g., top genre, top three genres, etc.) and/or preferred content types (e.g., top type, tope three types, etc.), based on the ordered list of content (e.g., based on a quantity of times a respective genre and/or type, respectively, occurs in the ordered list of content).

CDS 140 may identify a COI associated with user device 110 based on the message activity (e.g., between user device 110 and the preferred user devices 110) and/or web activity (e.g., between user devices 110 and preferred content providers 150 associated with user device 110 and/or the preferred user devices 110). For example, CDS 140 may, in a manner similar to that described above, identify respective other preferred content providers 110 associated with each of the preferred user devices 110. In another example, CDS 140 may, in a manner similar to that described above, identify respective other preferred content, content genres, content types, etc. for each of the preferred user devices 110. In yet another example, CDS 140 may, in a manner similar to that described above, identify respective other preferred user devices 110 (e.g., other friends) for each of the preferred user devices 110.

CDS 140 may identify a COI, associated with user device 110, based on all or a portion of the preferred user devices 110 and/or the other preferred user devices 110; the preferred content providers 150 and/or the other preferred content providers 150; and/or the preferred content, genres, types, etc. and/or the other preferred content, genres, types, etc. CDS 140 may store the information, associated with the COI, in a memory associated with CDS 140.

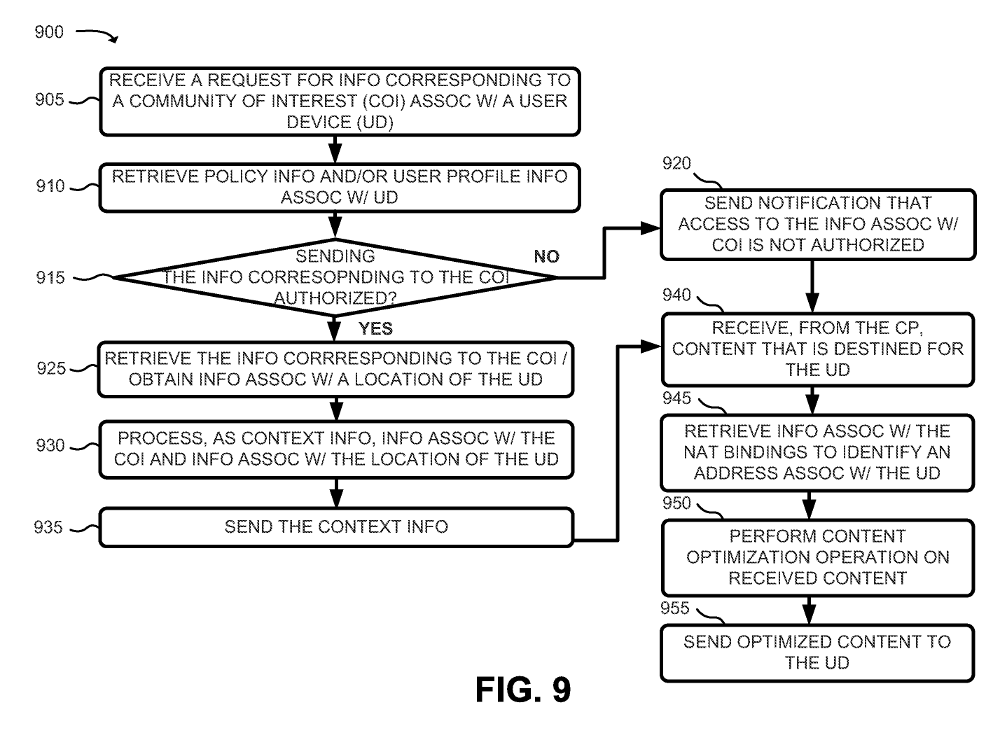

FIG. 9 is a flow chart of an example process 900 for performing content optimization on content being served to user device 110. In one example implementation, process 900 may be performed by CDS 140. In another example implementation, some or all of process 900 may be performed by a device or collection of devices separate from, or in combination with, CDS 140.

As shown in FIG. 9, process 900 may include receiving a request for information corresponding to a COI associated with user device 110 (block 905). For example, CDS 140 may receive a request, from content provider 150, for information corresponding to a COI associated with user device 110, which content provider 150 may use to tailor and/or customize content for user device 110. In another example implementation, CDS 140 may automatically initiate an operation to determine whether to send, to content provider 150, the information corresponding to the COI regardless of whether the request is received from content provider 150.

As also shown in FIG. 9, process 900 may include retrieving policy information and/or user profile information associated with user device 110 (block 910). For example, CDS 140 may receive the request and may retrieve (e.g., from a PCRF server, associated with service provider network 160, via a Gx interface) policy information associated with service provider network 160. CDS 140 may use the policy information to determine whether a SLA, associated with content provider 150, has been executed. CDS 140 may determine whether sending the information, corresponding to the COI, is authorized based on whether the SLA has been executed and/or whether terms and/or conditions, specified by the SLA, indicate that the information, corresponding to the COI, is authorized to be sent.

In another example, CDS 140 may, in response to the request, retrieve (e.g., from a HSS associated with service provider network 160) user profile information associated with user device 110. CDS 140 may, for example, use the user profile information to determine whether a user, of user device 110, has authorized sending the information, corresponding to the COI, to content provider 150. In another example, CDS 140 may use the user profile information to determine whether the user authorizes sending information, associated with a location of user device 110, to content provider 150.

As further shown in FIG. 9, if sending the information corresponding to the COI is not authorized (block 915—NO), then process 900 may include sending a notification that access to the information associated with the COI is not authorized (block 920). For example, CDS 140 may determine, from the policy information, that a SLA, associated with content provider 150, has not been executed. Additionally, or alternatively, CDS 140 may determine that terms and/or conditions, associated with an executed SLA, do not authorize sending the information corresponding to the COI to content provider 150. In another example, CDS 140 may determine, from the user profile information, that the user, of user device 110, does not authorize sending the information, corresponding to the COI, to content provider 150.

Based on the determination that sending the information, corresponding to the COI associated with user device 110, is not authorized, CDS 140 may send, to content provider 150, a notification that access to the information, corresponding to the COI associated with user device 110, is not authorized.

As yet further shown in FIG. 9, if sending the information, corresponding to the COI, is authorized (block 915—YES), then process 900 may include retrieving the information associated with the COI and/or retrieving information associated with a location of user device 110 (block 925). For example, CDS 140 may determine, from the policy information, that the SLA, associated with content provider 150, has been executed. Additionally, or alternatively, CDS 140 may determine that terms and/or conditions, associated with the executed SLA, authorize sending the information corresponding to the COI to content provider 150. In another example, CDS 140 may determine, from the user profile information, that the user authorizes sending the information, corresponding to the COI, to content provider 150.

Based on the determination that sending the information, corresponding to the COI associated with user device 110, is authorized, CDS 140 may retrieve the information corresponding to the COI. Additionally, or alternatively, based on the determination that sending the information, associated with the location of user device 110, is authorized, CDS 140 may retrieve the information, associated with a location of user device 110. CDS 140 may, in one example, use an LBS API to communicate with service provider network 160 in order to obtain the information associated with a location of user device 110.

As also shown in FIG. 9, process 900 may include processing, as context information, the information corresponding to the COI and/or the information associated with the location of user device 110 (block 930) and sending the context information (block 935). For example, CDS 140 may process the information, corresponding to the COI associated with user device 110, by removing and/or extracting, from the information corresponding to the COI, information that may permit content provider 150 to identify the user and/or user device 110. CDS 140 may, for example, remove a device identifier (e.g., MDN, IMSI, SIM URI, etc.), a device address (e.g., an IP address, a media access control (MAC) address, etc.) and/or information associated with the user (e.g., username, password, personal identification number (PIN), etc.).

Additionally, or alternatively, CDS 140 may process the information associated with a location of user device 110 by removing, from the information associated with the location of user device 110, other information that may permit content provider 150 to identify the user or user device 110. CDS 140 may, for example, extract and/or remove particular information associated with the location of user device 110 (e.g., a physical address, a billing address, etc. associated with the user) and/or information associated with the user and/or user device 110. In another example, CDS 140 may convert the information, associated with the location of user device 110, from a high level of granularity (e.g., a physical address, latitude and/or longitude coordinates, etc.) to a level of granularity that is less than the high level of granularity, such as a geographical area within which user device 110 is located (e.g., an area that corresponds to a zip code, a town, a county, an area covered by a cell, etc.).

CDS 140 may send, to content provider 150 (e.g., as context information associated with user device 110), the processed information that corresponds to the COI associated with user device 110 and/or the processed information associated with the location of user device 110.

As further shown in FIG. 9, process 900 may include receiving content that is destined for user device 110 (block 940) and retrieving information associated with NAT bindings to identify an address associated with user device 110 (block 945). For example, content provider 150 may generate content that is tailored and/or customized for user device 110 based on the information associated with the COI and/or the location of user device 110. In another example, content provider 150 may generate content that is not tailored and/or customized for user device 110 when content provider 150 is not authorized to access the information corresponding to the COI and/or associated with the location of user device 110. Content provider 150 may automatically, or upon the occurrence of some event (e.g., a request from CDS 140), send the content to CDS 140.

CDS 140 may receive the content and may retrieve information, associated with NAT bindings that correspond to user device 110, based on a destination IP address associated with user device 110 obtained from the content. CDS 140 may use the information associated with the NAT bindings to identify an internal IP address (e.g., an IP address used by service provider network 160), associated with user device 110, that corresponds to the destination IP address obtained from the content. Additionally, or alternatively, CDS 140 may use information associated with an application programming network (APN) and/or information associated with a port (e.g., via which CDS 140 communicates with content provider 150) to identify an internal IP address corresponding to user device 110.

As still further shown in FIG. 9, process 900 may include performing a content optimization operation on the received content (block 950) and sending the optimized content to user device 110 (block 955). For example, CDS 140 may perform an optimization operation on the content in a manner similar to that described above (e.g., with respect block 435 of FIG. 4) that enables the content to be efficiently transported to user device 110 (e.g., at a maximum data rate and/or bandwidth that does not cause congestion), at a QoS associated with an SLA, and/or that enables user device 110 to receive, process, and/or render the content within a period of time that is less than a threshold). Additionally, or alternatively, CDS 140 may cause content to be served to user device 110 in a manner that minimizes and/or avoids conditions present on a RAN associated with service provider network 160 in a manner similar to that described above (e.g., with respect to blocks 605-615 of FIG. 6).

Systems and/or methods, described herein, may enable content, obtained from one or more content providers, to be temporarily stored, and/or transported to a user device in a manner that minimizes utilization of bandwidth, processing, and/or other resources associated with the service provider network. The systems and/or methods may perform RAN modeling by monitoring traffic being transported via cells, associated with the RAN, via which the service provider network communicates with user devices. The systems and/or methods may use information obtained as a result of the RAN modeling to determine whether a condition (e.g., congestion, jitter, packet delay and/or loss, mis-ordered packets, etc.) exists in the RAN. The systems and/or methods may perform an operation that avoids and/or remedies a condition while ensuring that content, being transported to a user device, is sent in a manner that satisfies a minimum QoS.

The systems and/or methods may monitor traffic that is being received and/or outputted by the service provider network. The systems and/or methods may use information, obtained from monitoring the traffic, to identify preferred content providers from which a user device obtains content, preferred user devices with which the user device communicates, and/or preferred content that the user device and/or the preferred user devices access, used, and/or obtain. The systems and/or methods may use information associated with the preferred content providers, preferred user devices, and/or preferred content to identify a COI associated with the user device. The systems and/or methods may use the information, associated with the COI, to assist content providers in targeting content to user devices and/or the preferred user devices.

The systems and/or methods may perform an operation to optimize the content being served to the user device. The systems and/or methods may convert the content into a tailored format that can be easily rendered by a variety of types of user devices. The systems and/or methods may process the content to ensure that the traffic can be transmitted to the user device at maximum through while avoiding congestion and/or other network conditions.

The foregoing description provides illustration and description, but is not intended to be exhaustive or to limit the implementations to the precise form disclosed. Modifications and variations are possible in light of the above teachings or may be acquired from practice of the embodiments.

While series of blocks have been described with regard to FIGS. 4, 6, 8, and 9 the order of the blocks may be modified in other implementations. Further, non-dependent blocks may be performed in parallel.

It will be apparent that systems and/or methods, as described above, may be implemented in many different forms of software, firmware, and hardware in the implementations illustrated in the figures. The actual software code or specialized control hardware used to implement these systems and methods is not limiting of the embodiments. Thus, the operation and behavior of the systems and methods were described without reference to the specific software code—it being understood that software and control hardware can be designed to implement the systems and methods based on the description herein.

Further, certain portions, described above, may be implemented as a component that performs one or more functions. A component, as used herein, may include hardware, such as a processor, an ASIC, or a FPGA, or a combination of hardware and software (e.g., a processor executing software).

It should be emphasized that the terms “comprises”/“comprising” when used in this specification are taken to specify the presence of stated features, integers, steps or components but does not preclude the presence or addition of one or more other features, integers, steps, components or groups thereof.

Even though particular combinations of features are recited in the claims and/or disclosed in the specification, these combinations are not intended to limit the disclosure of the embodiments. In fact, many of these features may be combined in ways not specifically recited in the claims and/or disclosed in the specification. Although each dependent claim listed below may directly depend on only one other claim, the disclosure of the embodiments includes each dependent claim in combination with every other claim in the claim set.

No element, act, or instruction used in the present application should be construed as critical or essential to the embodiments unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method, performed by a content distribution system associated with a service provider network, the method comprising:
receiving, by the content distribution system and from a content provider, a request for information associated with a community of interest (COI) that corresponds to a user device,
determining, by the content distribution system, whether the content provider is authorized to receive the information associated with the COI based on a policy associated with the service provider network;
retrieving, from a storage device associated with the content distribution system, the information associated with the COI based on a determination that the policy information includes an indication that the content provider is authorized to receive the information associated with the COI;
sending, by the content distribution system and to the content provider, the information associated with the COI, where the information, associated with the COI, enables the content provider to generate content that is customized for the user device;
receiving, by the content distribution system and from the content provider, the content that is customized for the user device; and
sending, by the content distribution system and to the user device via the service provider network, the content that is customized for the user device.

2. The method of claim 1, where the information associated with the COI includes at least one of:
information associated with one or more preferred user devices with which the user device communicates,
information associated with one or more preferred content providers with which the user device or the one or more preferred user devices communicate, or
information associated with preferred content accessed or obtained by the user device or the one or more preferred user devices.

3. The method of claim 2, further comprising:
obtaining, from traffic associated with the user device, information associated with a plurality of user devices with which the user device communicates; and
identifying the one or more preferred user devices based on a respective quantity of times that the user device communicates with each of the plurality of user devices.

4. The method of claim 2, further comprising:
obtaining, from traffic associated with the user device and the one or more preferred user devices, information associated with a plurality of content providers from which the user device and the one or more preferred user devices obtain or access a plurality of content;
generating an ordered list of the plurality of content providers based on a respective quantity of times that the user device and the one or more preferred user devices obtain or access a respective portion of the plurality of content from each of the plurality of content providers; and
identifying the one or more preferred content providers based on the ordered list of the plurality of content providers.

5. The method of claim 4, further comprising:
obtaining, from the traffic associated with the user device and from other traffic associated with the preferred user devices, information associated with the plurality of content that is accessed or obtained from the plurality of content providers;
generating an ordered list of the plurality of content based on a respective quantity of times that the user device and the preferred user devices access or obtain each item of content, of the plurality of content; and
identifying the preferred content based on the ordered list of the plurality of content.

6. The method of claim 1, where determining whether the content provider is authorized to receive the information associated with the COI, includes:
sending a query, to a server device associated with the service provider network, to obtain the policy information, where the server device enforces policies associated with the service provider network; and
determining, as a result of the query to obtain the policy information, that the policy information includes the indication that the content provider is authorized to receive the information associated with the COI.

7. The method of claim 1, where determining whether the content provider is authorized to receive the information associated with the COI, further includes:
sending a query, to the service provider network, to obtain information associated with a user profile that corresponds to the user device; and
determining, as a result of the query to obtain the information associated with the user profile, that the information associated with the user profile indicates that a user, of the user device, has authorized the content provider to receive the information associated with the COI.

8. The method of claim 1, further comprising:
temporarily storing, in the storage device, the content that is customized to the user device.

9. The method of claim 1, where sending the information associated with the COI further includes:
determining whether information, associated with the user device, is included in the information associated with the COI; and
extracting, from the information associated with the COI, the information associated with the user device based on a determination that the information, associated with the COI, includes the information associated with the user device.

10. The method of claim 1, where receiving the customized content further includes:
obtaining, from the content that is customized for the user device, a first Internet protocol (IP) address associated with the user device;
retrieving, from the storage device, information associated with network access transfer (NAT) bindings based on the first IP address; and
identifying, from the information associated with the NAT bindings, a second IP address that corresponds to the first IP address, where the second IP address is used by the service provider network to serve the content, that is customized for the user device, to the user device.

11. The method of claim 1, where sending the content that is customized for the user device, further includes:
performing an operation to optimize the content that is customized for the user device, where the operation to optimize the content includes at least one of:
resizing packets, associated with the content that is customized for the user device, in a manner that corresponds to a maximum transmission unit (MTU) associated with the service provider network,
converting the content, that is customized for the user device, to a format that permits the user device to process or render the content, that is customized for the user device, within a quantity of time that is less than a threshold, or
sending the content, that is customized for the user device, at a data rate that corresponds to a maximum data rate, associated with the service provider network, without causing congestion in the service provider network.

12. A content distribution system, associated with a service provider network, the content distribution system comprising:
a storage device to temporarily store content that is generated by one or more of a plurality of content providers;
a distribution server to:
receive, from a user device associated with the service provider network, a request for particular content associated with one of the plurality of content providers;
determine, in response to the request, whether the particular content is stored in the storage device, and
retrieve, from the storage device, the particular content, based on a determination that the particular content is stored in the storage device; and
an optimization server to:
perform an optimization operation on the content to:
convert the particular content to a format that reduces a time associated with processing or rendering the particular content on the user device, or
process the particular content in a manner that permits the particular content to be served to the user at a data rate or a bandwidth that is greater than a threshold without causing the service provider network to become congested, and output the particular content to the user device via the service provider network.

13. The content distribution system of claim 12, where the distribution server is further to:
determine that a service level agreement (SLA) has been executed with a particular content provider, of the plurality of content providers,
send, to the particular content provider, a request for content hosted by the particular content provider based on the determination that the SLA has been executed,
receive, from the particular content provider, the content hosted by the particular content provider, and
temporarily store the particular content in the storage device.

14. The content distribution system of claim 12, where, when determining whether the content is stored in the storage device, the distribution server is further to:
send, to the one of the plurality of content providers, a query to obtain information associated with the particular content, where the information, associated with the particular content, includes temporal information associated with the particular content,
compare the obtained information, associated with the particular content, to information, associated with the particular content, that is stored in the storage device, and
identify that the content is stored in the storage device when the obtained information, associated with the particular content, matches the stored information associated with the particular content.

15. The content distribution system of claim 12, where the distribution server is further to:
determine that other content associated with a particular content provider, of the plurality of content providers, is not stored in the storage device, and
obtain the other content from the particular content provider based on the determination that the other content is not stored in the storage device.

16. The content distribution system of claim 12, further comprising:
an analytical server to:
monitor traffic being sent to or received from the user device to identify information associated with user habits of the user device, where the information associated with the user habits includes at least one of:
one or more preferred content providers, of the plurality of content providers,
one or more preferred user devices, of a plurality of user devices with which the user device communicates, or
one or more preferred content genres accessed or obtained by the user device; and
send, to the one or more content providers, the information associated with the user habits, where the information associated with the user habits enables the one or more content providers to generate content that is customized for the user device.

17. The content distribution system of claim 16, where the analytical server is further to:
monitor other traffic being sent to or received from the one or more preferred user devices;
identify user habits associated with the one or more preferred user devices, where information associated with the user habits associated with the one or more preferred user devices includes:
one or more other preferred content providers, of the plurality of content providers, or
one or more other preferred content genres accessed or obtained by the one or more preferred user devices;
identify a community of interest associated with the user device based on the information associated with the user habits of the user device and information associated with the user habits associated with the one or more preferred user devices; and
output, to the one or more content providers, information associated with the community of interest.

18. The content distribution system of claim 12, where the content optimization server is further to:
receive, from a server device, a notification that a condition exists on a radio access network (RAN) via which the service provider network communicates with the user device,
where the server device performs operations to detect conditions on the RAN, and
where the condition indicates that at least one of jitter, congestion, lost packets, delayed packets, or mis-ordered packets, associated with traffic being transported via the RAN, has been detected; and
send an instruction to the service provider network that indicates that traffic is to be transported, via the RAN, in a manner that remedies the condition.

19. The content distribution system of claim 12, where performance of the optimization operation on the content is performed in a manner that does not change the content as perceived by a user of the user device.

20. A content distribution system, associated with a service provider network, the content distribution system comprising:
a storage device to store information, corresponding to a community of interest (COI) associated a user device, where the information associated with the COI identifies:
one or more preferred user devices, of a plurality of user devices, with which the user device communicates, or
one or more preferred content providers, of a plurality of content providers, from which the user device or the one or more preferred user devices obtain content;
a first server device to:
receive, from a content provider of the plurality of content providers, a request for the information associated with the COI,
send, in response to the request, the information associated with the COI obtained from the storage device,
receive, from the content provider, particular content that is customized for the user device based on the information associated with the COI; and
a second server device to:
receive, from a third server device, a notification that a condition exists on a radio access network (RAN) via which the service provider network is to serve the particular content to the user device,
identify, in response to the notification, a manner in which traffic is to be transported, to the user device via the RAN, that remedies the condition, and
output, to the user device and via the service provider network and the RAN, the particular content in the manner that remedies the condition.

21. The content distribution system of claim 20, where the first server device is further to:
temporarily store, in the storage device, the particular content, and
update, the information associated with the COI, based on a genre associated with the particular content or information associated with the content provider from which the particular content was received.

22. The content distribution system of claim 21, where the first server device is further to:
receive, from the user device, a request for the particular content,
retrieve, from the storage device, information associated with a version that corresponds to the particular content,
send, to the content provider, a query to obtain information associated with a version that corresponds to the particular content that is hosted by the content provider, and
retrieve, from the storage device, the particular content based on a determination that the stored information associated with the version matches the obtained information associated with the version.

23. The content distribution system of claim 20, where the first server device is further to:
retrieve, from the service provider network, information associated with a location of the user device, and
send, to the content provider, the information associated with the location of the user device that enables the content server to customize the particular content for the user device based on the location of the user device.

24. The content distribution system of claim 20, where the second server device is further to:
perform an optimization operation on the particular content in a manner that:
converts the particular content to a format that permits the user device to process or render the particular content within a period of time that is less than a threshold, or
permits the particular content to be served to the user at a bandwidth that is greater than a threshold without causing the service provider network or the RAN to become congested.

25. The content distribution system of claim 24, where, when performing the optimization operation on the particular content, the second server device is to:
compress packets associated with the particular content,
resize the packets associated with the content relative to a maximum transmission unit associated with the service provider network or RAN,
output the particular content at a particular data rate that is greater than the threshold, or
reduce a quantity of acknowledgment packets associated with outputting the particular content in a manner that increases a quantity of the bandwidth that is available to transport the particular content.
